(19) United States
(12) Patent Application Publication
(10) Pub. No.: US 2012/0327232 A1
(43) Pub. Date: Dec. 27, 2012

(54) Automobile Equipment Control System and Control Method Thereof

(75) Inventors: Tai-Chang Yang, Kaohsiung City (TW); Yin-Pin Chang, Zhubei City (TW); Wen-Yan Chang, Hsinchu (TW); Hong-Long Chou, Taipei City (TW)

(73) Assignee: ALTEK CORPORATION, Hsinchu (TW)

(21) Appl. No.: 13/207,857

(22) Filed: Aug. 11, 2011

(30) Foreign Application Priority Data
Jun. 23, 2011 (TW) 100122060

(51) Int. Cl. H04N 7/18; G06K 9/00

(52) U.S. Cl. 348/148; 382/118; 348/E07.085

(57) ABSTRACT

An automobile equipment control system and a control method thereof. The system comprises an input module, a storage module, an image capturing module, a first recognizing module, a second recognizing module and a processing module. The input module is used to input a plurality of vehicle equipment setting values. The storage module is used to save a plurality of facial characteristic values and a plurality of setting values of vehicle equipment. The image capturing module is used to capture the image of the user. The first recognizing module analyzes the facial image in the image and extracts a facial characteristic point from the facial image. The second recognizing module analyzes the user's hand gesture, the user's head gestures or what the user speaks so as to decide which setting value of vehicle equipment is adopted to control the vehicle equipment.

### FIELD OF THE INVENTION

The present invention relates to an automobile equipment control system and a control method thereof, in particular to an automobile equipment control system that combines facial recognition, hand gesture recognition, voice recognition or head movement recognition device to provide various setting for automobile equipment.

### BACKGROUND OF THE INVENTION

At present, it is vary common that multiple persons use one car in a family or company. Each driver has a different height, weight, sex and habits, so he/she has to adjust the height and inclination of a steering wheel and a seat every time, and thus it is very inconvenient, particularly for drivers with a different sex and a very different build. In addition, a good sitting posture is very important to the driving safety, and a driver's seat capable of fitting the driver's build can efficiently reduce blind spots, avoid hindrances of vision caused by the car body, windshield, or windows, facilitating the driver to observe the road condition, prevent car accidents, and facilitate parking a car. In general, a car seat is adjusted by using two to three sets of memory buttons, and such traditional way of adjusting the car seat lacks of scalability and cannot work when multiple people use the one car. Obviously, the traditional way fails to meet the requirements of different drivers with different body builds.

In addition, different drivers have different requirements of lighting, air-conditioning temperature and music volume. In a traditional central control system of a car, the driver can just make adjustments manually.

In addition to the requirement of adjusting the steering wheel and seat, the drivers usually listen to a broadcasting program in the car. Since drivers have their own favorite programs, therefore the channels are switched frequently when multiple people use the one car. If a driver wants to change to a different broadcasting program, the driver needs to search for the desired channel, but the traditional automobile central control system can set approximately one to two channels only, and is very inconvenient.

Further, car stereo is one of the most popular automobile equipment, and each driver usually puts their own favorite music CD or DVD into a stereo player. When many people share to use one car, the driver has to switch the CD or DVD frequently to find his/her favorite music CD, and it not only cause inconvenience, but also distract the driver during driving and easily cause a car accident.

Currently, the humanized man-machine interface of car is becoming more and more important, and the concept of smart cars has become a main development focus for major car manufacturers and another business opportunity for driving the growth of the world's electronic industry. With the promotions of major car manufacturers, automobile electronic manufacturers and semiconductor chip manufacturers, the functions and features of the smart cars are established gradually. The electromechanical integration and the electronic automobile system are the main differences between the smart cars and the traditional cars.

Therefore, how to improve the traditional method of adjusting the car seat and overcome the problem of insufficient scalability demands immediate attentions, which leads to the problem of requiring to re-adjust the seat and steering wheel frequently when multiple drivers share one car and fails to meet the body builds of different drivers. In addition, it is necessary to overcome the aforementioned problem that the users can only manually adjust the air conditioning, lighting and stereo by the traditional control system and have to switch and listen frequently in order to find out the users' own favorite music CD or radio program. To sum up, the goal of present invention is to develop a more humanized man-machine interface for the new-generation smart cars.

### SUMMARY OF THE INVENTION

In view of the shortcomings of the prior art, it is a primary objective of the present invention to provide an automobile equipment control system to overcome the problems of the prior art requiring a complicated control method to control an automobile equipment system to adjust the settings of the automobile equipment and having a poor scalability.

To achieve the foregoing objective, the present invention provides an automobile equipment control system, comprising a storage module for storing at least one facial characteristic value and at least one automobile equipment setting value; an image capturing module, for capturing an image; a first recognizing module, electrically coupled to the image capturing module, for analyzing a facial image in the image and extracting a facial characteristic point from the facial image; a second recognizing module, for analyzing a user's natural interaction to generate a recognition signal; a processing module, electrically coupled to the storage module, the first recognizing module, the second recognizing module and at least one automobile equipment, for comparing the facial characteristic point with and at least one facial characteristic value and analyzing the recognition signal to generate an analysis result, and retrieving one of the automobile equipment setting values from the storage module according to the analysis result to control the operation of at least one automobile equipment.

The automobile equipment control system further comprises an input module, electrically coupled to the storage module for inputting at least one automobile equipment setting value.

Preferably, the automobile equipment can be a car seat, audio-video equipment, illumination equipment, air-conditioning equipment, network equipment and navigation equipment.

Preferably, the second recognizing module can be a voice recognition module, and the user's natural interaction can be voice, and the recognition signal can be a voice recognition signal, and the second recognizing module is provided for analyzing the user's voice to generate the voice recognition signal and transmit the voice recognition signal to the processing module.

Preferably, the second recognizing module can be a head movement recognition module, and the user's natural interaction can be a head movement, and the recognition signal can be a head movement recognition signal, and the second recognizing module is provided for analyzing the user's head movement to generate the head movement recognition signal, and transmit the head movement recognition signal to the processing module.

Preferably, the second recognizing module can be a hand gesture recognition module, and the user's natural interaction can be a hand gesture, and the recognition signal can be a hand gesture recognition signal, and the second recognizing module is provided for analyzing the user's hand gesture to generate the hand gesture recognition signal and transmit the hand gesture recognition signal to the processing module.

In addition, the present invention further provides a method of controlling automobile equipment, comprising the steps of using a storage module to store at least one facial characteristic value and at least one automobile equipment setting value; using an image capturing module to capture an image; using a first recognizing module to analyze a facial image in the image, and extract a facial characteristic point from the facial image; using a second recognizing module to analyze a user's natural interaction to generate a recognition signal; using a processing module to compare the facial characteristic value with the facial characteristic point and analyze the recognition signal to produce an analysis result, and retrieve one set of automobile equipment setting values from the storage module to control the operation of the automobile equipment according to the analysis result.

Preferably, the control method of the automobile equipment control system further comprises the step of using an input module to input at least one equipment setting value.

Preferably, the automobile equipment can be a car seat, audio-video equipment, illumination equipment, air-conditioning equipment, network equipment and navigation equipment.

Preferably, the second recognizing module can be a voice recognition module, and the user's natural interaction can be a voice, and the recognition signal can be a voice recognition signal.

Preferably, the second recognizing module can be a head movement recognition module, and the user's natural interaction can be a head movement, and the recognition signal can be a head movement recognition signal.

Preferably, the second recognizing module can be a hand gesture recognition module, and the user's natural interaction can be a hand gesture, and the recognition signal can be a hand gesture recognition signal.

In addition, the present invention further provides an automobile equipment control system, comprising means for storing at least one facial characteristic value and at least one automobile equipment setting value; means for capturing an image; means for analyzing a facial image in the image, and then extracting a facial characteristic point from the facial image; means for analyzing a user's natural interaction to generate a recognition signal; means for comparing the facial characteristic point with the at least one facial characteristic value, and analyzing the recognition signal to produce an analysis result; and means for retrieving one of the at least one automobile equipment setting value from the storage module according to the analysis result to control the operation of the at least one automobile equipment.

Preferably, the automobile equipment can be a car seat, audio-video equipment, illumination equipment, air-conditioning equipment, network equipment and navigation equipment.

Preferably, the user's natural interaction can be voice, and the recognition signal can be a voice recognition signal.

Preferably, the user's natural interaction can be head movement, and the recognition signal can be a head movement recognition signal.

Preferably, the user's natural interaction can be hand gesture, and the recognition signal can be a hand gesture recognition signal.

To sum up, the present invention has one or more of the following advantages:

(1) The automobile equipment control system uses the first recognizing module to determine the user's identity quickly and retrieve at least one automobile equipment setting value set by the user and stored in the storage module. The second recognizing module is provided for the user to select an equipment setting value through a simple natural interaction, so as to overcome the problem of the prior art and the inconvenient use of the automobile equipment that requires users to adjust the seat, steering wheel and air-conditioning frequently.

(2) The automobile equipment control system uses the storage module to store a plurality of automobile equipment setting values, and the second recognizing module is provided for users to select the automobile equipment setting value through a simple hand gesture, etc., so as to overcome the insufficient scalability of the prior art.

(3) The automobile equipment control system uses the input module to input automobile equipment setting value of the specified user, so that the user can lock a desired radio channel or music CD, and switch to a desired channel or music CD quickly. Therefore, the problems of the prior art can be overcome, such that the user no longer need to switch radio channels or music CDs frequently.

The technical characteristics and effects of the present invention will become apparent in the detailed description of the preferred embodiments with reference to the accompanying drawings as follows.

### BRIEF DESCRIPTION OF THE DRAWINGS

FIG. 1 is a block diagram of an automobile equipment control system in accordance with a first preferred embodiment of the present invention;

FIG. 2 is a schematic view of an actual application of an automobile equipment control system in accordance with a second preferred embodiment of the present invention;

FIG. 3 is a flow chart of operating an automobile equipment control system in accordance with the second preferred embodiment of the present invention;

FIG. 4 is a schematic view of an actual application of an automobile equipment control system in accordance with a third preferred embodiment of the present invention;

FIG. 5 is a flow chart of operating an automobile equipment control system in accordance with the third preferred embodiment of the present invention;

FIG. 6 is a schematic view of an actual application of an automobile equipment control system in accordance with a fourth preferred embodiment of the present invention;

FIG. 7 is a flow chart of operating an automobile equipment control system in accordance with the fifth preferred embodiment of the present invention; and

FIG. 8 is a flow chart of a method of controlling an automobile equipment control system in accordance with the present invention.

### DESCRIPTION OF THE PREFERRED EMBODIMENTS

The technical characteristics and contents of the present invention will become apparent with the following detailed description and related drawings. It is noteworthy to point out that same numerals are used for representing respective same elements in the drawings.

The automobile equipment control system and its control method in accordance with the present invention can be applied to household or company passenger cars or trucks, but they can also be applied to private aircraft or passenger airplanes, or even public transportation systems such as trains, buses, mass rapid transits and high speed rail. For simplicity, the passenger car is provided for illustrating the technical characteristics of the present invention, and it is noteworthy to point out that the invention is not limited to the application for passenger cars only.

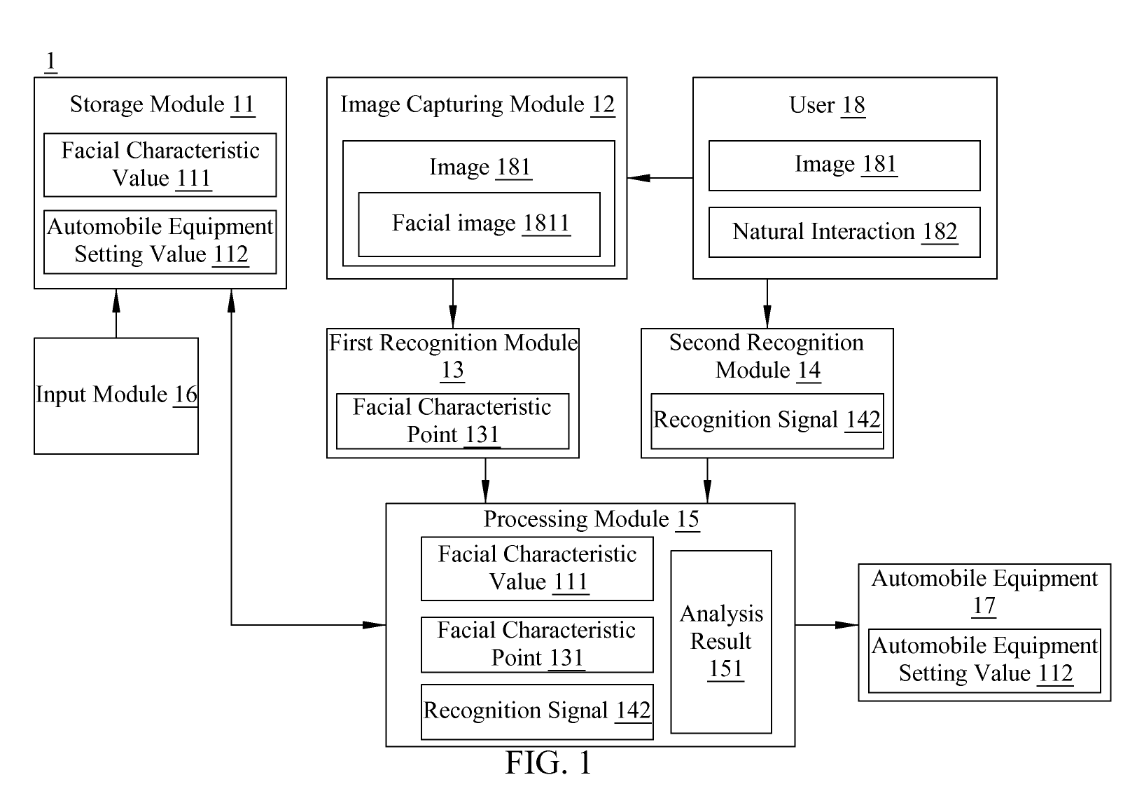

With reference to FIG. 1 for a block diagram of an automobile equipment control system in accordance with the first preferred embodiment of the present invention, the automobile equipment control system 1 comprises a storage module 11, an image capturing module 12, a first recognizing module 13, a second recognizing module 14, a processing module 15 and an input module 16. The storage module 11 is provided for storing a facial characteristic value 111 and an automobile equipment setting value 112. Unlike the traditional central control system of an automobile capable of storing a small number of common utility settings, the storage module 11 of the invention can store a plurality of customized automobile equipment setting value 112. The image capturing module 12 is provided for capturing an image 181 of a user 18 and includes a sensing component such as a complementary metal oxide semiconductor (CMOS) or a charge coupled device (CCD).

The first recognizing module 13 is electrically coupled to the image capturing module 12, for analyzing a facial image 1811 of the image 181, and extracting a facial characteristic point 131. In addition, the first recognizing module 13 has a facial detection function applied for detecting the dynamic status in a car. For example, the air-conditioning, sound and light in a car can be adjusted according to the condition whether or not there is a passenger on each seat to provide a comfortable ride. Further, a closed-eye detection function can be integrated into the first recognizing module 13, so that the air-conditioning, sound and light can be adjusted according to the condition whether or not the passenger in each seat falls asleep.

The second recognizing module 14 is provided for analyzing a natural interaction 182 of the user and generating a recognition signal 142. It is noteworthy to point out that the natural interaction refers to some instinctive movement such as a voice, a hand gesture and a body movement, and the user can use a simple body movement or short voice to achieve the effect of an operation. In addition, the second recognizing module 14 is not limited to recognizing just one kind of natural interactions only, but it can recognize a plurality of natural interactions. For example, the voice and hand gesture or even the voice, hand gesture and head movement are combined for controlling an operation.

The processing module 15 is electrically coupled to the storage module 11, the first recognizing module 13, the second recognizing module 14 and the automobile equipment 17, and comparing the facial characteristic point 131 with the facial characteristic value 111 to determine an identity of the user 18. If the user 18 has registered with the system, the processing module 15 in conjunction with the recognition signal 142 will produce an analysis result 151, and extract one of the automobile equipment setting values 112 from the storage module 11 according to the analysis result 151 to control the operation of the automobile equipment 17, such as setting the position of a steering wheel, the inclination of a seat, repeating playing the same music CD, staying tuned to the channel of a specific broadcasting program, adjusting the sound volume, controlling an automobile digital TV program, and setting the air-conditioning and light, etc. In addition, the processing module 15 can further have a self-learning function. For example, when the user 18 adjusts the steering wheel and the position of a seat manually, and places a new music CD into a stereo player, the settings are recorded automatically, and such settings will be used for the next time when the user 18 uses the car again.

Besides, all those skilled in the art may randomly combine the functional modules into an integrated means or divide them into each detailed functional means, depending on the convenience of design.

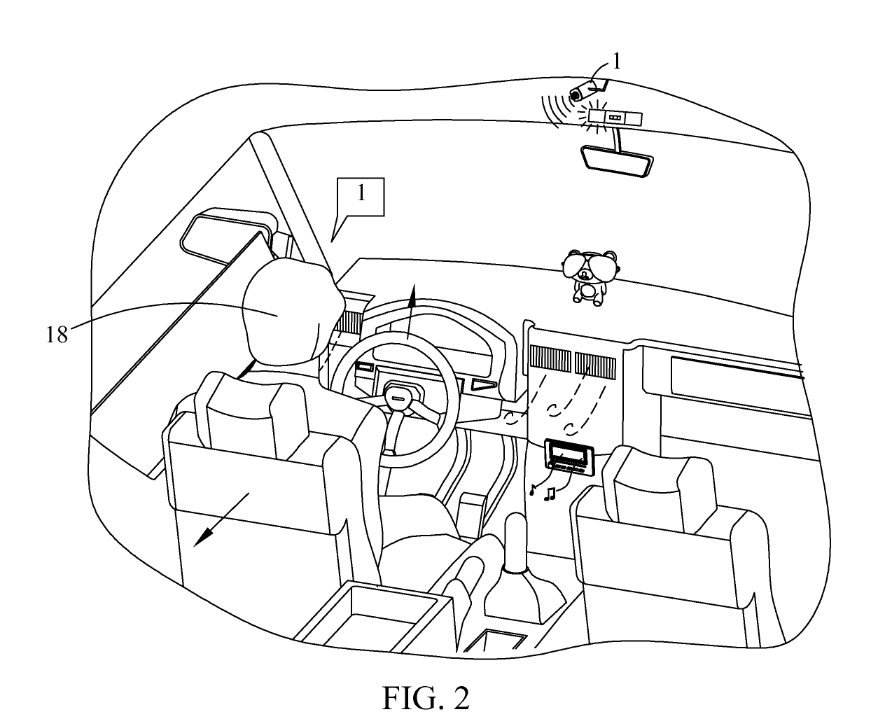

With reference to FIG. 2 for a schematic view of an actual application of an automobile equipment control system in accordance with the second preferred embodiment of the present invention, the natural interaction 182 of the second recognizing module 14 is a voice. In other words, the second recognizing module 14 is a voice recognition module for analyzing the voice of the user 18 to generate a recognition signal 142 which is a voice recognition signal.

In FIG. 2, when the user 18 enters the car and gets into a driver's seat, the image capturing module 12 captures an image 181 of the user 18. Now, the first recognizing module 13 starts analyzing a facial image 1811 in the image 181 and extracts the facial characteristic point 131 from the facial image 1811. The processing module 15 compares the facial characteristic point 131 with the facial characteristic value 111 stored in the storage module 11 to determine the identity of the user 18 and locate the set of corresponding automobile equipment setting values 112 stored in the storage module 11. If there is only one set of corresponding automobile equipment setting values 112, then the processing module 15 will set the automobile equipment according to the only one set of automobile equipment setting values 112. If there are two or more sets of corresponding automobile equipment setting values 112, then the automobile equipment control system 1 will request the user 18 to enter a natural interaction 182 of voice. In FIG. 2, the user 18 says the number “1”, and the second recognizing module 14 analyzes the number “1” and understands that the user 18 wants to adopt the first set of setting values, and a recognition signal 142 will be generated. The processing module 15 compares the facial characteristic point 131 with the facial characteristic value 111 to find the identity of the user 18 and produces an analysis result 151 according to the recognition signal 142 to hereby retrieve the corresponding automobile equipment setting values 112 and set the automobile equipment 17. Persons ordinarily skilled in the art should understand that the type of voice is not limited to numbers only, but it can be “Yes” or “No”. Similarly, the type of voice is not limited to Chinese, but it can be English or any other languages, depending on the actual application requirements.

Of course, invalid data may be inputted sometimes. For example, the user 18 says the number “3”, but there are only two sets of corresponding automobile equipment setting values 112 stored in the storage module 11, then the processing module 15 will be unable to retrieve the corresponding automobile equipment setting value 112. Similarly, the user 18 has not been registered in some case, so that no facial characteristic value 111 of the user 18 is stored in the storage module 11, and there will be no corresponding automobile equipment setting value 112. Now, the system will enter into the registration procedure.

It is noteworthy to point out the advantage of storing a plurality sets of automobile equipment setting values 112 is that the user 18 can adjust the automobile equipment 17 at will according to the weather, the road condition, the number of passengers, or even the user's mood to meet the requirements of different situations flexibly. For example, a news channel is set automatically when the user is on the way to work, and a light music channel is set automatically when the user is on a vacation trip, or the air conditioner of the passenger seats is turned on when there are passengers sitting in the passenger seats. Since the automobile equipment setting value 112 can be customized according to the user's preference, a more humanized man-machine interface is provided. For example, a music CD chosen by the user 18 can be played constantly and all other unchosen CDs are locked, such that the user 18 can always switch to the desired music CD album; or a broadcasting channel chosen by the user 18 is locked, such that the user 18 can switch to the user's favorable channel quickly to save much time.

Further, the automobile equipment control system 1 of the present invention can have a self-learning function that the processing module 15 can automatically record the settings of the automobile equipment 17 set by the user 18 manually. For example, when the user 18 enters a car and gets into a driver's seat, the image capturing module 12 captures the image 181 of the user 18, and the first recognizing module 13 analyzes the facial image 1811 in the image 181 and extract the facial characteristic point 131, and stores the facial characteristic point 131 in the storage module 11. The user 18 places a new music CD into an automobile stereo player, increases steering wheel, lowers the seat, tunes the volume, or adjusts the air conditioner, and the processing module 15 will record these settings and store the settings in the storage module 11. When the user 18 gets into the driver's seat again, the automobile equipment control system 1 confirms the identity of the user 18 through the first recognizing module 13, and the aforementioned settings will be used in first priority.

On the other hand, the automobile equipment control system 1 of the present invention can be integrated with an anti-theft function, such that an anti-theft system has a plurality of identification functions. For example, the anti-theft system has both facial recognition and voice recognition functions. When the user 18 gets into the driver's seat, and the first recognizing module 13 carries out a facial recognition to confirm the user's identity. Meanwhile, the automobile equipment control system 1 requests the user 18 to input a specific voice provided for the second recognizing module 14 to perform a voiceprint recognition to confirm the legitimate right of use of the user 18. After the procedure of confirming the user's identity is completed, the procedure enters into an automobile equipment setting procedure.

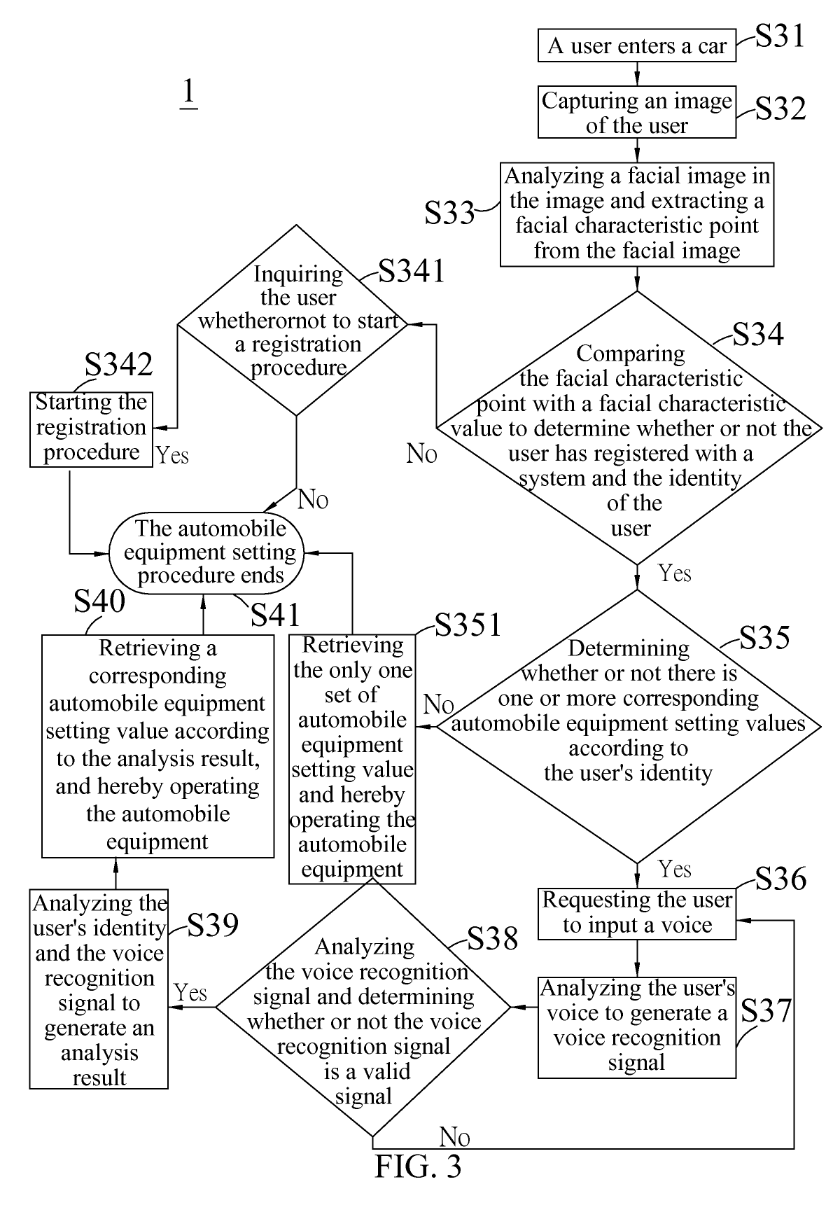

With reference to FIG. 3 for a flow chart of operating an automobile equipment control system in accordance with the second preferred embodiment of the present invention, the control method of the automobile equipment control system of the invention comprises the following steps.

In Step S31, a user enters a car.

In Step S32, an image capturing module captures an image of the user.

In Step S33, a first recognizing module analyzes a facial image in the image and extracts a facial characteristic point.

In Step S34, a processing module compares the facial characteristic point with a facial characteristic value stored in the storage module to determine whether or not the user has registered with a system and determine the identity of the user. If yes, it shows that the user has registered with the system, and the identity of the user will be identified, and the procedure will enter into Step S35. If no, it shows that the user has not registered in the system, and the procedure will enter into Step S341.

In Step S341, the system inquires the user whether or not to start a registration procedure. If yes, then the procedure will enter into Step S342 to start the registration procedure. After the registration procedure is completed, the procedure enters into Step S41 to end the automobile equipment setting procedure. If not, the procedure will enter into Step S31 to directly end the automobile equipment setting procedure.

In Step S35, the processing module determines whether or not there is one or more corresponding automobile equipment setting values set by the user in the storage module according to the user's identity. If yes, it shows that the user has stored multiple sets of automobile equipment setting values for the user to choose from, and then the procedure will enter into Step S36. If no, it shows that the user just stores one set of automobile equipment setting values in the system, and the procedure will enter into Step S351.

In Step S351, the processing module retrieves the only one set of automobile equipment setting values from the storage module and inputs the set of automobile equipment setting values into the automobile equipment for operating the automobile equipment. After the input is completed, the procedure enters into Step S41 to end the automobile equipment setting procedure.

In Step S36, the system requests the user to input a voice.

In Step S37, the second recognizing module analyzes the user's voice to generate a voice recognition signal.

In Step S38, the processing module analyzes the voice recognition signal and determines whether or not the voice recognition signal is a valid signal. If yes, it shows that the voice recognition signal is a valid input, and the procedure enters into Step S39. If no, it shows that the voice recognition signal is an invalid input, and it is necessary to re-enter, and the procedure returns to Step S36 wherein the system requests the user to enter a voice.

In Step S39, the processing module analyzes the user's identity and the voice recognition signal to generate an analysis result.

In Step S40, the processing module retrieves a corresponding automobile equipment setting value from the storage module according to the analysis result, and inputs the automobile equipment setting value to the automobile equipment for operating the automobile equipment.

In Step S41, the automobile equipment setting procedure ends.

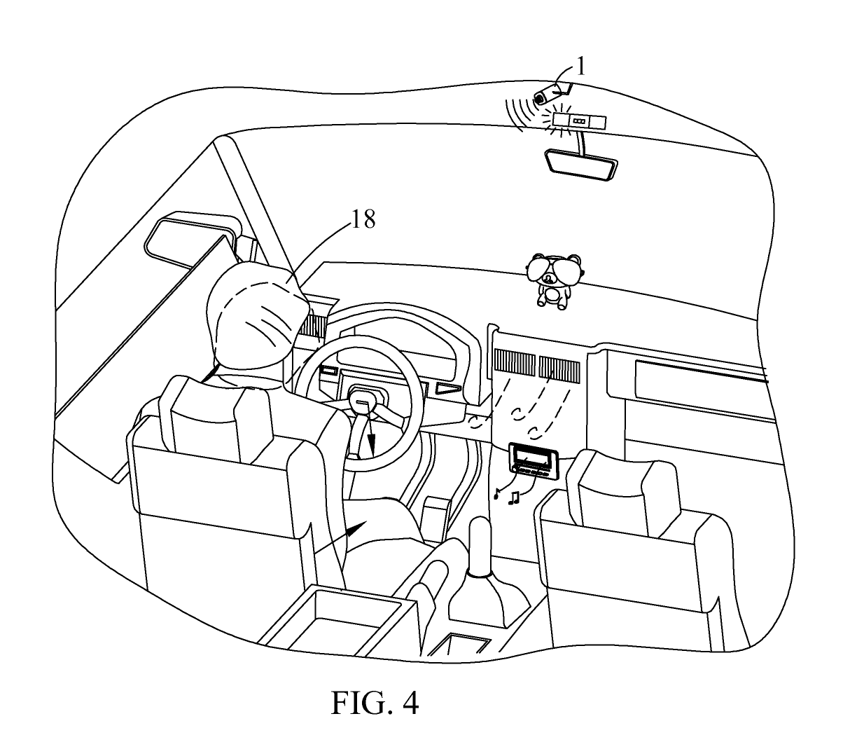

With reference to FIG. 4 for a schematic view of an actual application of an automobile equipment control system in accordance with the third preferred embodiment of the present invention, the difference between this preferred embodiment and the second preferred embodiment are that the natural interaction 182 recognized by the second recognizing module 14 is a head movement in this preferred embodiment. In other words, the second recognizing module 14 is a head movement recognition module for analyzing a head movement of the user 18 to generate a recognition signal 142 which is a head movement recognition signal.

Unlike the second preferred embodiment, if the user 18 has two or more sets of automobile equipment setting values 112, the processing module 15 will sequentially execute the two or more sets of automobile equipment setting values 112 and request the user 18 to input a natural interaction 182 such as a head movement (which is nodding or shaking head in the preferred embodiment). In FIG. 4, when the user 18 gets into the driver's seat, the automobile equipment control system 1 of the present invention starts setting a steering wheel, a seat, an air-conditioning, music and light etc., and the user 18 uses “nodding” to represent agreeing the current settings, and the second recognizing module 14 analyzes the movement of “nodding” and understands that the user 18 agrees with the current settings, so that a recognition signal 142 will be generated. The processing module 15 compares a facial characteristic point 131 with a facial characteristic value 111 to find the identity of the user 18 and produces an analysis result 151 according to the recognition signal 142 to hereby determine whether current settings are kept or another set of automobile equipment setting values 112 is executed.

Similarly, the natural interaction 182 recognized by the second recognizing module 14 can be a hand gesture. In other words, the second recognizing module 14 is a hand gesture recognition module for analyzing a hand gesture of the user 18 to generate a recognition signal 142 which is a hand gesture recognition signal.

In addition, persons ordinarily skilled in the art should understand that the second recognizing module 14 can includes two or more natural interaction recognition functions. For example, the second recognizing module 14 can include both head movement and hand gesture recognition functions, and the automobile equipment control system 1 of the present invention can execute the automobile equipment setting value 112 most frequently used by the user 18 first, and confirms the setting value 112 according to the nodding of the user 18. After the car has been driven for a period of time, if the user 18 wants to change the automobile equipment setting value 112, the user can use a hand gesture for changing the setting. Of course, there can be a plurality of natural interaction recognition functions of the second recognizing module 14, depending on the requirement of actual applications.

Similarly, the second recognizing module 14 with two or more natural interaction recognition functions can be used for operating different automobile equipments 17. For example, a hand gesture is used for operating a car stereo to play different music CDs, and a voice is used for switching the channel f a digital TV.

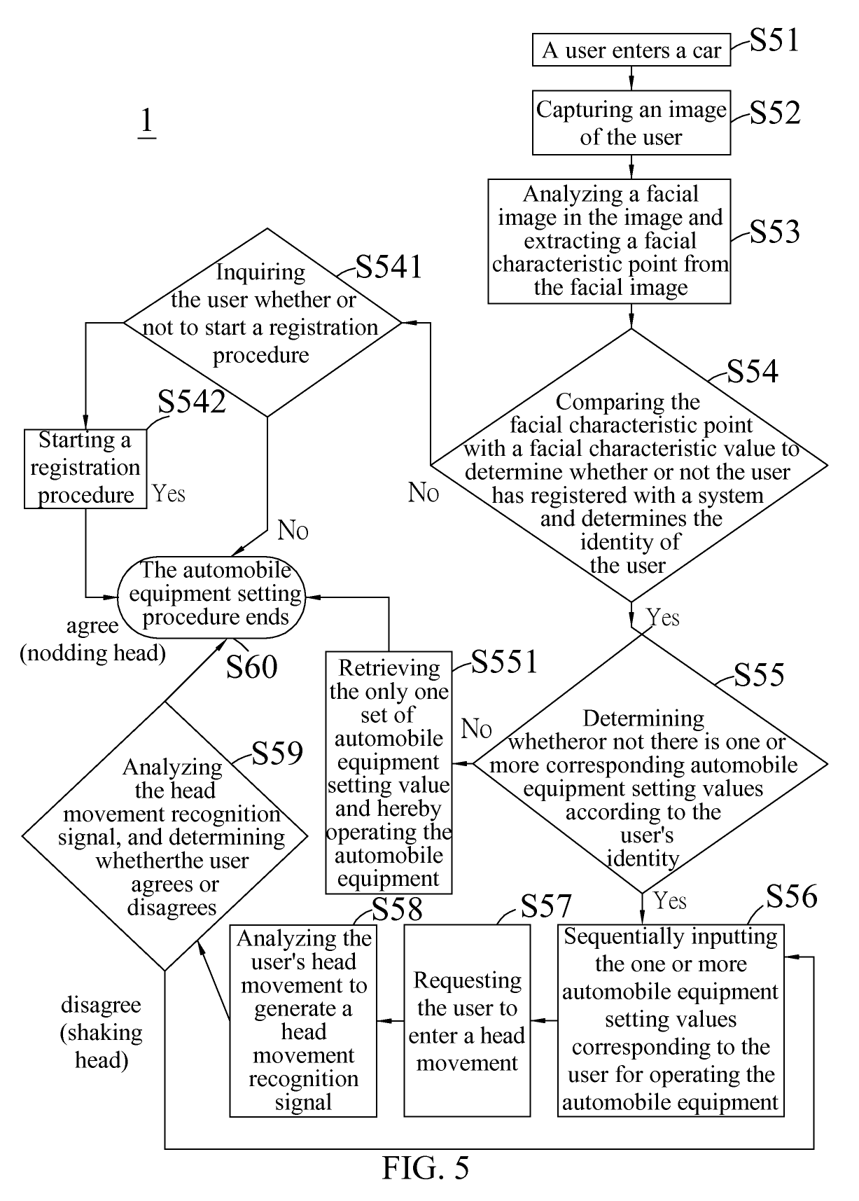

With reference to FIG. 5 for a flow chart of operating an automobile equipment control system in accordance with the third preferred embodiment of the present invention.

In Step S51, a user enters a car.

In Step S52, an image capturing module captures an image of the user.

In Step S53, a first recognizing module analyzes a facial image in the image and extracts a facial characteristic point.

In Step S54, a processing module compares the facial characteristic point with a facial characteristic value stored in a storage module to determine whether or not the user has registered with a system and determines the identity of the user. If yes, it shows the user has registered with the system, such that the identity of the user will be determined, and then the procedure will enter into Step S45. If no, it shows the user has not registered with the system, and the procedure will enter into Step S441.

In Step S541, the system inquires the user whether or not to start a registration procedure. If yes, then the procedure will enter into Step S542 to start the registration procedure. The procedure will enter into Step S50 after the registration procedure is completed and then will end the automobile equipment setting procedure. If not, the procedure will enter directly into Step S50 and will end the automobile equipment setting procedure.

In Step S55, the processing module determines whether or not there is one or more corresponding automobile equipment setting values set by the user in the storage module according to the user's identity. If yes, it shows that the user has store plural sets of automobile equipment setting values for choices, and then the procedure enters into Step S56. If not, it shows that the user just stores one set of automobile equipment setting values in the system, and the procedure will enter into Step S551.

In Step S551, the processing module retrieves the only one set of automobile equipment setting values from the storage module and inputs the set of automobile equipment setting value to operate the automobile equipment. The procedure enters into Step 60 and ends the automobile equipment setting procedure after the input is completed.

In Step S56, the processing module sequentially inputs the one or more equipment setting values in the storage module corresponding to the user for operating the automobile equipment.

In Step S57, the system requests the user to enter a head movement (nodding or shaking the user's head).

In Step S58, the second recognizing module analyzes the user's head movement to generate a head movement recognition signal.

In Step S59, the processing module analyzes the head movement recognition signal, and determines whether the user agrees (by nodding the user's head) or disagrees (by shaking the user's head). If the user agrees (by nodding the user's head), it shows that the user accepts the current automobile equipment setting value, and the procedure will enter into Step S60. If the user disagrees (shaking the user's head), then it shows that the user does not accept the current automobile equipment setting value, and it is necessary to change to another set of automobile equipment setting values, and the procedure returns to Step S56, so that the processing module sequentially inputs the user's one or more equipment setting values corresponding to the automobile equipment into the storage module for operating the automobile equipment.

In Step S60, the automobile equipment setting procedure ends.

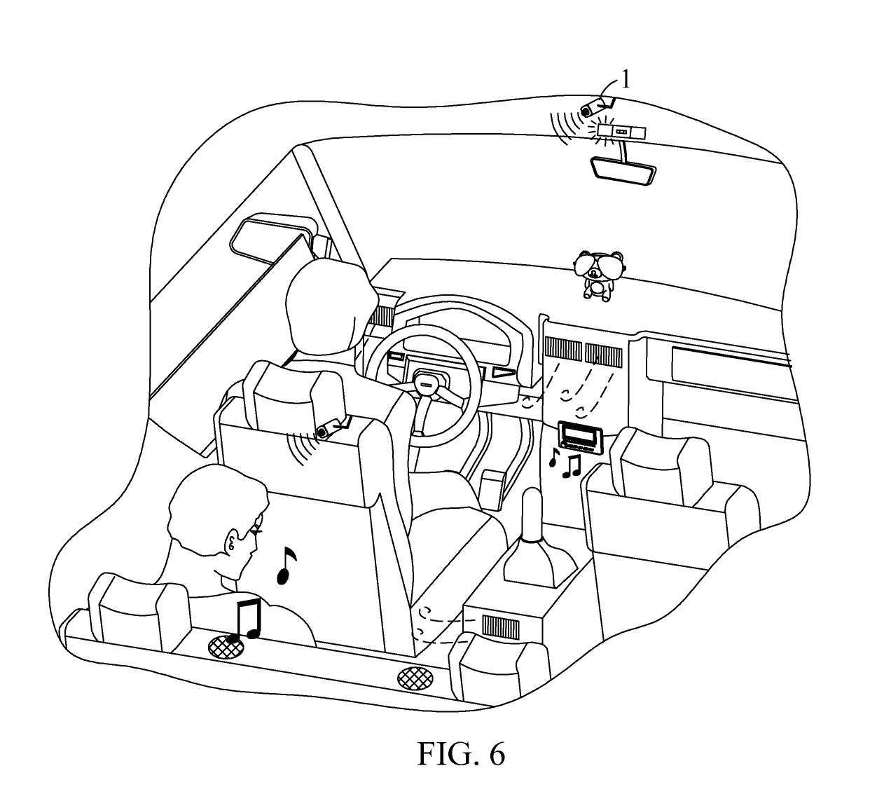

With reference to FIG. 6 for a schematic view of an actual application of an automobile equipment control system in accordance with the fourth preferred embodiment of the present invention; the present invention, when there is a passenger in the backseat, the automobile equipment control system 6 with the vehicle cabin dynamic detection function detects the passenger in the backseat and turns on the backseat air conditioning and stereo, so that the passenger at the backseat can be more comfortable. In addition, the air conditioner can be turned on or off by detecting whether or not there are passengers in the backseat.

In addition, persons skilled ordinarily in the art should understand that the automobile equipment control system 1 of the present invention is not limited to the positions of the rear mirror or the rear of the driver's seat, but also covers the positions of the door of the driver's seat, the door of the backseat, or being above the steering wheel. The image capturing module 12 and the second recognizing module 14 can be installed separately, depending on the requirement of the actual application.

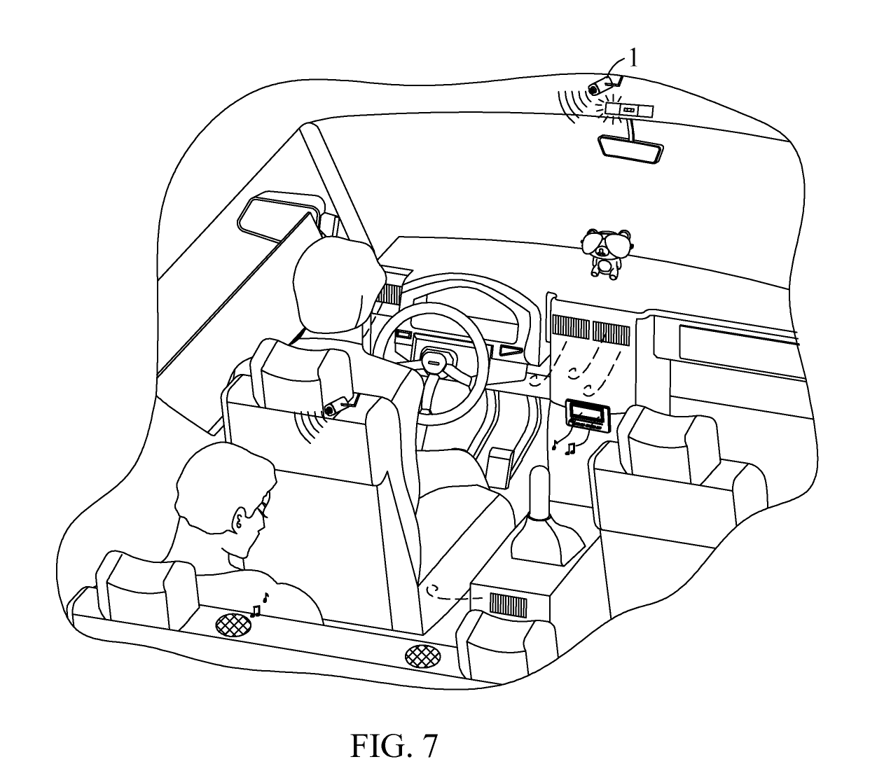

With reference to FIG. 7 for a flow chart of operating an automobile equipment control system in accordance with the fifth preferred embodiment of the present invention the present invention, the automobile equipment control system 1 with a closed-eye detection function detects that a passenger closes eyes at a backseat and the temperature of the air conditioning at the backseat and the sound volume of the stereo of the backseat can be adjusted to an appropriate level to provide a comfortable resting environment for the passenger. In the meantime, a warning signal can be transmitted to the driver, so that the driver knows about the condition of the passenger at the backseat passenger. Of course, this function can be applied to the driver's seat as sell. If a driver closes eyes on a driver's seat, the automobile equipment control system 1 issues the warning signal to remind the driver to take breaks before proceeding to drive. In addition, the system can also detect whether or not the passenger keep tilting his head for a period of time to hereby determine whether or not the passenger falls asleep.

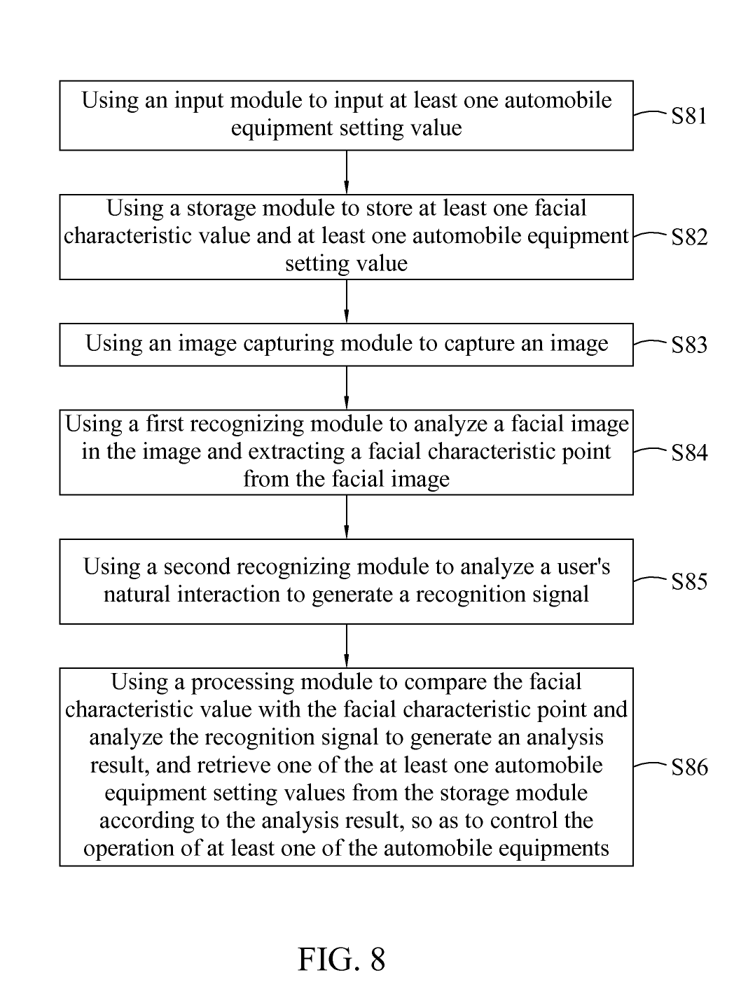

With reference to FIG. 8 for a flow chart of a control method of an automobile equipment control system in accordance with the present invention, the control method is applicable for an automobile equipment control system, and the automobile equipment control system comprises an input module, a storage module, an image capturing module, a first recognizing module, a second recognizing module, a processing module. The control method of the automobile equipment control system comprises the following steps:

(S81) Using an input module to input at least one automobile equipment setting value;

(S82) Using a storage module to store at least one facial characteristic value and at least one automobile equipment setting value;

(S83) Using an image capturing module to capture an image;

(S84) Using a first recognizing module to analyze a facial image in the image and extract a facial characteristic point from the facial image;

(S85) Using a second recognizing module to analyze a user's natural interaction to generate a recognition signal; and

(S86) Using a processing module to compare the facial characteristic value with the facial characteristic point and analyze the recognition signal to generate an analysis result, and retrieve one of the at least one automobile equipment setting values from the storage module according to the analysis result, so as to control the operation of at least one of the automobile equipments.

The control method of an automobile equipment control system in accordance with the present invention has been described in the section of the implementation of the automobile equipment control system already, and thus the control method will be described briefly as follows.

To sum up, the automobile equipment control system and its control method of the present invention can determine a user's identity quickly, and retrieve the automobile equipment setting values set by the user and stored in the system for the user's choice. The user can use simple natural interactions to control the system to operate the automobile equipment and store plural sets of automobile equipment setting values. Therefore, the automobile equipment control system and its control method of the present invention not only improving the insufficient scalability and inconvenient operation of the prior art, but also providing an excellent man-machine interface for the new-generation smart cars.

What is claimed is:

1. An automobile equipment control system, comprising:
a storage module storing at least one facial characteristic value and at least one automobile equipment setting value;
an image capturing module capturing an image;
a first recognizing module electrically coupled to the image capturing module, analyzing a facial image in the image, and then extracting a facial characteristic point from the facial image;
a second recognizing module analyzing a user's natural interaction to generate a recognition signal;
a processing module electrically coupled to the storage module, the first recognizing module, the second recognizing module and at least one automobile equipment, comparing the facial characteristic point with the at least one facial characteristic value, and analyzing the recognition signal to produce an analysis result, and retrieving one of the at least one automobile equipment setting value from the storage module according to the analysis result to control the operation of the at least one automobile equipment.

2. The automobile equipment control system of claim 1, further comprising an input module electrically coupled to the storage module, inputting the at least one automobile equipment setting value.

3. The automobile equipment control system of claim 2, wherein the automobile equipment is a car seat, audio-video equipment, illumination equipment, air-conditioning equipment, network equipment and navigation equipment.

4. The automobile equipment control system of claim 3, wherein the second recognizing module is a voice recognition module, and the user's natural interaction is voice, and the recognition signal is a voice recognition signal, and the second recognizing module analyzes the user's voice to generate the voice recognition signal and transmit the voice recognition signal to the processing module.

5. The automobile equipment control system of claim 3, wherein the second recognizing module is a head movement recognition module, and the user's natural interaction is head movement, and the recognition signal is a head movement recognition signal, and the second recognizing module analyzes the user's head movement to generate the head movement recognition signal and transmit the head movement recognition signal to the processing module.

6. The automobile equipment control system of claim 3, wherein the second recognizing module is a hand gesture recognition module, and the user's natural interaction is hand gesture, and the recognition signal is a hand gesture recognition signal, and the second recognizing module analyzes the user's hand gesture to generate the hand gesture recognition signal, and transmit the hand gesture recognition signal to the processing module.

7. A control method of an automobile equipment control system, comprising the steps of:
using a storage module to store at least one facial characteristic value and at least one equipment setting value;
using an image capturing module to capture an image;
using a first recognizing module to analyze a facial image in the image, and then retrieve a facial characteristic point from the facial image;
using a second recognizing module to analyze a user's natural interaction to generate a recognition signal;
using a processing module to compare the facial characteristic value with the facial characteristic point, and analyze the recognition signal to produce an analysis result, and retrieve one of the at least one equipment setting value stored in the storage module to control at least one automobile equipment according to the analysis result.

8. The control method of an automobile equipment control system as recited in claim 7, further comprising the step of: using an input module to input the at least one automobile equipment setting value.

9. The control method of an automobile equipment control system as recited in claim 8, wherein the automobile equipment is a car seat, audio-video equipment, illumination equipment, air-conditioning equipment, network equipment and navigation equipment.

10. The control method of an automobile equipment control system as recited in claim 9, wherein the second recognizing module is a voice recognition module, and the user's natural interaction is voice, and the recognition signal is a voice recognition signal.

11. The control method of an automobile equipment control system as recited in claim 9, wherein the second recognizing module is a head movement recognition module, and the user's natural interaction is head movement, and the recognition signal is a head movement recognition signal.

12. The control method of an automobile equipment control system as recited in claim 9, wherein the second recognizing module is a hand gesture recognition module, and the user's natural interaction is hand gesture, and the recognition signal is a hand gesture recognition signal.

13. An automobile equipment control system, comprising:
means for storing at least one facial characteristic value and at least one automobile equipment setting value;
means for capturing an image;
means for analyzing a facial image in the image, and then extracting a facial characteristic point from the facial image;
means for analyzing a user's natural interaction to generate a recognition signal;
means for comparing the facial characteristic point with the at least one facial characteristic value, and analyzing the recognition signal to produce an analysis result; and
means for retrieving one of the at least one automobile equipment setting value from the storage module according to the analysis result to control the operation of the at least one automobile equipment.

14. The automobile equipment control system of claim 13, wherein the automobile equipment is a car seat, audio-video equipment, illumination equipment, air-conditioning equipment, network equipment and navigation equipment.

15. The automobile equipment control system of claim 13, wherein the user's natural interaction is voice, and the recognition signal is a voice recognition signal.

16. The automobile equipment control system of claim 13, wherein the user's natural interaction is head movement, and the recognition signal is a head movement recognition signal.

17. The automobile equipment control system of claim 13, wherein the user's natural interaction is hand gesture, and the recognition signal is a hand gesture recognition signal.
